(19) United States
(12) Patent Application Publication
(10) Pub. No.: US 2008/0320068 A1
(43) Pub. Date: Dec. 25, 2008

(54) Wideband suppression of motion-induced vibration

(76) Inventors: David G. Bowling, Albuquerque, NM (US); Gregory P. Starr, Albuquerque, NM (US)

Correspondence Address: VALAUSKAS & PINE LLC, Suite 1825, 150 North Wacker Drive, Chicago, IL, 60606, US

(21) Appl. No.: 12/069,717

(22) Filed: Feb. 12, 2008

Related U.S. Application Data
(60) Provisional application No. 60/900,899, filed on Feb. 12, 2007.

(51) Int. Cl. G06F 17/10

(52) U.S. Cl. 708/300

(57) ABSTRACT

The present invention is a new method to create motions based on the use of rate limited profiles convolved with FIR kernel filters, termed herein as Rate limited Boxcar Aliased IFIR (RBAI) motions, or profiles. The present invention demonstrates a simpler generalized view of the creation of pulse-based profiles based on digital signal processing windowing techniques. The method turns windowing functions into an IFIR filter using boxcar functions for the interpolation. The IFIR filter smoothes the pulse-based profiles, allowing the resultant filter to be applied directly over a simple rate limited base profile. The resulting motion profiles suppress residual vibration over a much wider band of frequencies than previous methods.

This application claims the benefit of U.S. Provisional Application No. 60/900,899 filed Feb. 12, 2007.

### STATEMENT CONCERNING FEDERALLY SPONSORED RESEARCH

The present invention was partially developed with government support under Grant No. DE-FG52-04NA25590 awarded by the Department of Energy. As a result, the Government may have certain rights in this invention.

### FIELD OF THE INVENTION

The present invention relates to motion control. More specifically, the present invention relates to creating a pulse-based motion profile using rate limited profiles convolved with FIR kernel filters. The resulting motion profiles suppress residual vibration over a much wider band of frequencies than previous methods.

### BACKGROUND OF THE INVENTION

Motion control is present in every aspect of everyday life. Two basic types of motion control exist, position control and velocity control. Pure velocity control is used in devices such as conveyor belts, cars, trains, and aircraft. Position control is used on machines such as robots, numerical control mills, or any device that requires movement from one point to another.

The generation of motion profiles is the foundation of all motion control. Two basic types of profiles exist to control motion of a system, position-time profiles and spatial profiles. Position-time and spatial profiles work together to completely determine the motion of a system. Time profiles determine distance and velocity along the path, whereas position profiles determine the path. A position profile moves from one steady state position to the next steady state position.

Position-time profiles are used to control the position and velocity of motion as function of time or distance along a path. Position-time profiles mainly ramp up and down velocity, or modify velocity. Ramping usually occurs at the beginning and end of the profile, but velocity can be ramped at any point on the profile.

Spatial profiles are the paths that multidimensional motion traverses in either two-dimensional (2D) or three-dimensional (3D) space. If the required motion path is a straight line, a simple profile generator can be used to break the motion down into each individual axis. If a more complex motion involving curves and bends is required, the motion must be broken down into each individual axis as well as the traverse of the path determined.

A problem with motion profiles is residual vibration. The simplest of systems, for example, the conveyor belt at a grocery store checkout, a telescope, and an elevator, all have vibration issues when the system experiences movement.

The conveyor belt at any checkout line uses a simple on/off method to control the movement of the belt. This on/off control has the tendency to tip over an object such as a tall object with a small base, i.e., the topple effect. Current implementation of smooth profiles decreases toppling, but does not eliminate it. Also, current smooth profiles are not practical in low end motor controls used to drive conveyors since implementation is complicated. Controlling residual vibrations would eliminate the topple effect experienced by a conveyor system.

As another example, telescopes require precise motion and guidance to align the optics with the astronomical body to be observed. The optics tend to be fragile and may be susceptible to damage with abrupt motion. The use of impulse shaping motion control is not sufficient for this type of system because impulses may be imparted to the system, potentially causing damage. The basic requirement of a telescope motion system is not to induce any vibrations into the system or impart large impulses into the system. State of the art motion systems manage induced vibrations if driven slow enough, but infinitely continuous profiles that induce no vibration would vastly improve the productivity and speed of operation of a telescope.

Until recently, the velocity profiles used in elevators had constant acceleration at the beginning of the profile and a constant deceleration at the ending of the profile. The acceleration ramps up or down from one velocity to the next velocity as fast as possible resulting in the “bump” experienced at the beginning and end of the ride. This rapid change in acceleration is referred to herein as “jerk”. New systems use velocity profiles that limit jerk and the perceived bumps, but velocity profiles with infinitely continuous and magnitude limited derivatives may significantly improve the systems.

Previous approaches to creating profiles that eliminate or reduce residual vibrations have been explored. Previous approaches focused on creating profiles that eliminate or reduce the unwanted residual vibrations such as cycloid position profiles and profiles that act like notch filters eliminating a small set of predetermined frequency ranges.

Other approaches that eliminate or reduce residual vibrations include the Swing Free approach and the Input Shaping approach. The Swing Free approach shows that double pulse profiles can be designed to eliminate residual vibrations in a system. Due to the narrow notches in the frequency domain of Swing Free profiles, successful use of the technique is challenging on some systems. The Input Shaping approach improves upon the Swing Free approach in widening the frequency notch by adding extra pulses. Input Shaping approaches expand pulse profiles up to five pulses, but have no allowance for separate control of the width of the frequency notch. Input Shaping approaches further fail to allow an infinite upper frequency cutoff.

Other approaches created profiles that first excite then cancel out a range of frequencies in the system that is being driven, for example, using a two step velocity profile or double pulse profile. A two step velocity profile ramps up the velocity in two steps separated by half the period of the frequency of the system. A double pulse profile convolves a double pulse kernel with a position profile separated by half the period of the frequency of the system. The two step velocity profile or double pulse profile, in theory, completely eliminates the residual vibrations of a system with one known damped frequency. Therefore, if a system has multiple modes, or if the frequencies are not known, the two step velocity profile or double pulse profile may actually increase the residual vibration.

The use of low pass filters for position profiles has been considered by convolving a filter with a base profile. The difference between filter-based position profiles and general signal processing design is that there is no requirement for a band pass range for position profile kernels. Filter-based position profiles only require the pure direct current, or DC content, of a profile be passed without attenuation. In fact, outside of DC content it is undesirable for filter-based profiles to pass the input without some noticeable high frequency attenuation. The attenuation of kernels creates the smoothing or blending effects of the profiles. Filter-based position profiles also require that the gain at the DC content equal one. If not, the end point is overshot or never achieved.

All though most of the low pass filter techniques used for Digital Signal Processing (DSP) can be used for motion profile generation, special requirements for the profiles must be considered. Several aspects of the kernel design of position profiles are not crucial in DSP low pass filter design. In low pass filters, it is desired that the Gibbs effect is kept to a minimum. The Gibbs effect is the overshoot phenomenon exhibited by the truncated Fourier series at points of discontinuity. With a position profile, the Gibbs effect actually causes the end position to be overshot at certain drive frequencies. It is also critical that the output of a filter used to create profiles only have positive values. If the output drops below zero at any time, a “backward surge” of motion during the profile is experienced, which is an unacceptable side effect.

The use of a series of individual Swing Free pulses as shown in FIG. 1 or Input Shaping pulses shown in FIG. 2 can create profiles that will not result in residual vibration in a driven system. Swing Free and Input Shaping approaches first introduce vibrations into a system and cancel out the vibrations when the final pulse is applied. FIG. 1 shows a Swing Free approach with Δt_{SF}=π/ω. FIG. 1A shows the position profile, FIG. 1B the velocity profile, FIG. 1C the acceleration profile and FIG. 1D the frequency spectrum with ω=2 rad/sec.

FIG. 2 shows a series of frequency spectra produced by a three-hump extra-insensitive (EI) shaper. As shown in FIG. 2, the resulting spectra as successive pulses in an EI shaper are applied to a system. The first pulse creates a flat spectrum that excites all frequencies. As each additional pulse is added, the width of the notch increases and the magnitude of the spectrum decreases. If the pulse train is convolved with a step in position, a profile is generated that will not result in residual vibration over a given frequency range.

However, the position, velocity, and acceleration profiles that are created are not very smooth. The pulses can be substituted with continuous shapes, but the profile will still have a series of large-amplitude short-duration surges. Increasing the width of the pulse decreases the required acceleration amplitudes, causing the overall length of the kernel to grow resulting in longer transition times. Input Shaping as shown in FIG. 2 convolves the pulse trains with an existing smooth base profile. The base profile acts as a filter to smooth out the pulses, thus avoiding the need to give the pulses width.

The performance of everyday systems requiring motion can be improved with the development of easy to implement highly smooth vibration free continuous profiles. The present invention satisfies this demand.

### SUMMARY OF THE INVENTION

The current approach of Input Shaping ignores the potential contributions the base profile and pulse shaping can have on the profile. Input Shaping also ignores how pulse trains in the time domain create aliasing in the frequency domain. If the entire profile generation procedure is viewed as a signal processing problem including the base profile, simple pulse-based profiles can be generated that take advantage and build upon the concepts of Swing Free, Input Shaping, and aliasing.

The present invention creates smooth profiles with an improved frequency spectrum while maintaining computational efficiency equivalent to original Swing Free and Input Shaping approaches. Existing pulse-based and low pass profiles are introduced to rate limited base profiles as an underlying foundation to provide new profiles. With the use of boxcar filters the rate limited base profile is smoothed in the time domain creating continuous velocity and acceleration profiles. Pulse-based Input Shaping is generalized into alias-based profiles. The alias-based profiles are expanded to interpolated finite impulse response (IFIR) filters using boxcar filters to smooth in the time domain and act as anti-alias filters in the frequency domain.

The present invention is a new method to create motions based on the use of rate limited profiles convolved with FIR kernel filters, termed herein as Rate limited boxcar Aliased IFIR (RBAI) motions, or profiles. The present invention demonstrates a simpler generalized view of the creation of pulse-based profiles based on digital signal processing windowing techniques. The method turns the windowing functions into an IFIR filter using boxcar functions for the interpolation. The IFIR filter smoothes the pulse-based profiles, allowing the resultant filter to be applied directly over a simple rate limited base profile. These Rate limited Boxcar Aliased IFIR (RBAI) filters create profiles that have the same computational efficiency of Input Shaping profiles such as the three-hump EI Shaper but with capability to create profiles that act as low pass filters. The use of RBAI profiles allow for the width of the notch and the magnitude of the residual vibration in the frequency spectrum to be adjusted separately with no limitations on the number of pulses. Because the frequency spectrum and residual vibration can be controlled separately, the RBAI method produces profiles that are superior to the current Input Shaping approach. The resulting motion profiles suppress residual vibration over a much wider band of frequencies than previous methods.

As implemented, RBAI profiles allow for real-time update of end position and velocity. This is achieved by creating profiles solely from combinations of simple FIR filters.

One method for creating a pulse-based motion profile using a digital signal processing technique comprising the steps of presenting a continuous window filter and providing a rate limited base profile. The continuous window filter is designed as a low pass filter to suppress a wide range of frequencies. A continuous window filter is a simple shaped filter that is usually used in conjunction with another filter, but for purposes of the present invention, the window filter is used as the main filter. The continuous window filter is sampled and transformed into a discrete filter, which may cause aliasing in the frequency domain. The discrete filter is combined with the rate limited base profile, which may cause pulsing. One or more interpolated finite impulse response (IFIR) filters is applied to solve both problems of aliasing and pulsing. The IFIR filter interpolates data to smooth the data and acts as an anti-aliasing filter to remove aliasing. It is contemplated that one IFIR filter can be used provided the sampling time used to transform the continuous window filter into a discrete filter is chosen wisely. In one embodiment the boxcar function is used as the IFIR filter wherein the width of the boxcar function equals the time used to transform the continuous window filter into the discrete filter. The boxcar function smoothes the data to allow a simple rate limited profile to be used as the base profile. The boxcar function also performs anti-aliasing to suppress a wide range of frequencies.

An object of the invention is to generate smooth pulse-based position profiles with control of the smoothness and frequency spectrum of the profile.

Another object of the present invention is to generate smooth pulse-based position profiles generated real-time.

Another object of the present invention is to provide pulse trains that act as low pass filters to suppress a wider range of frequencies than existing pulse profiles.

Yet another object of the present invention is to exploit the frequency spectrum of the base profile and view pulse trains as sampled profiles that create aliasing in the frequency domain.

Yet another object of the present invention is to build profiles from simple components to generate profiles that allow position and velocity commands to be modified in real-time.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended figures provided to illustrate and not to limit the invention, in which:

FIG. 1 shows a Swing Free approach.

FIG. 2 shows an Input Shaping approach.

FIG. 3 shows a simple rate limited profile according to the present invention;

FIG. 4 shows a rate limited profile with a boxcar filter according to the present invention;

FIG. 5 shows a two pass boxcar filter profile according to the present invention;

FIG. 6 shows the derivative property of convolution created profiles according to the present invention;

FIG. 7 shows a sampled view of three-hump EI shaper according to the present invention;

FIG. 8 shows a velocity, acceleration, and jerk comparison between a Gaussian kernel and input shaper kernel according to the present invention;

FIG. 9 shows the effects of sampling of a continuous curve according to the present invention;

FIG. 10 shows the designing a pulse-based profile in the frequency domain according to the present invention;

FIG. 11 shows the effect of aligning a null point of a boxcar function with an aliasing peak according to the present invention; and

FIG. 12 shows the turning of pulse-based profiles into a linear segment continuous profile according to the present invention.

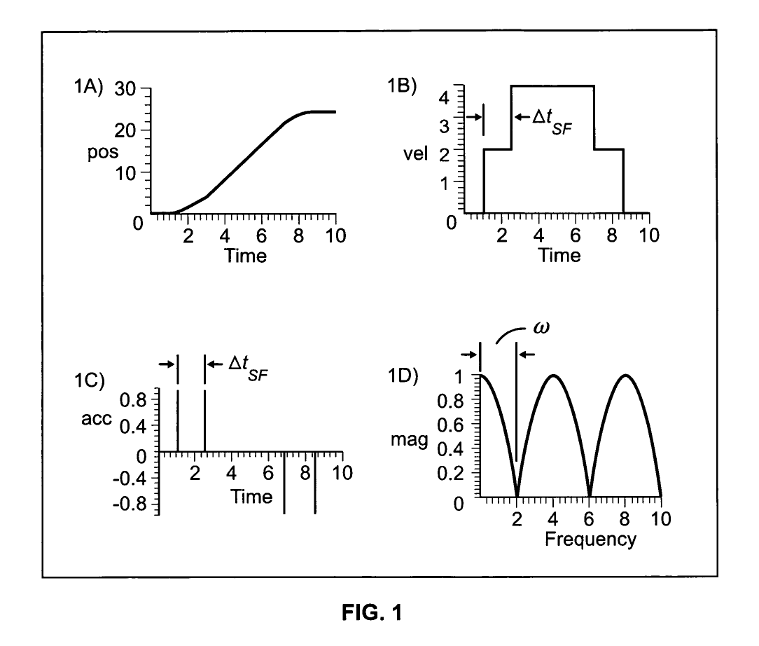

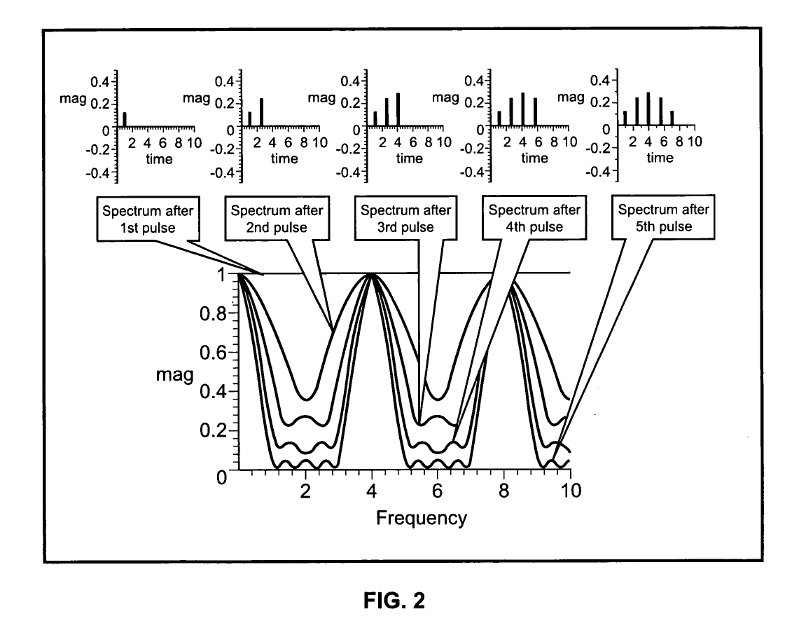

### DETAILED DESCRIPTION OF EMBODIMENTS OF THE INVENTION

The present invention is a method to generate a position-time profile. For purposes of this application, unless otherwise stated, all references to profiles and profile generation will imply position-time profiles. Within the realm of the position-time profile is the position versus time, velocity versus time, acceleration versus time, and all higher derivatives of the profiles versus time. Reference to position profiles, for example, will imply position versus time, and velocity profiles will imply velocity versus time.

Using a convolution operator, complex motion profiles can be built up from simple components. The three basic components according to the present invention include (1) rate limited profile, (2) Dirac pulse, and (3) boxcar function. The underlying foundation of all of the profiles is a rate limited profile. As the foundation of each profile, a rate limited profile controls the transient or slew velocity of the profile. Filtered pulse-based shaping is added to the rate limited profile.

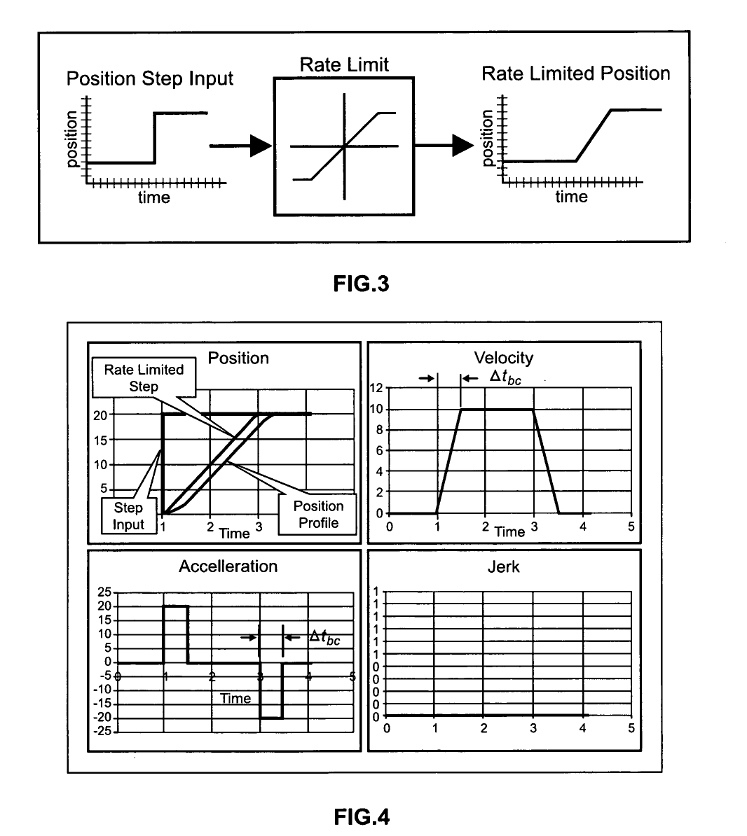

The simplest profile generation algorithm is a rate limited profile as shown in FIG. 3. If the desired end position, or required traverse distance (P_{f}), is passed through a rate limited profile, a ramp position profile is generated with a corresponding ramped velocity profile. The actual velocity profile is generated by differentiating the position profile (∪=d/dt(P)). The magnitude of the velocity profile (Vₘₐₓ) is set by the rate limited value (Vᵣₗ). The slew velocity is then held at the rate limited value. With infinite acceleration and jerk, a smooth profile is not generated. However, a rate limited profile generator has an advantage of requiring no initial computation, has no special cases and can be easily updated at any time with a new velocity or an end position with no recomputing. For example, changing the rate limited value (Vᵣₗ) or setting a new end position can be done with human input such as a manual knob to control velocity or final position. The rate limited profile also facilitates recomputing the profile if a new end position is entered during motion by simply passing the new end position into the rate limited profile. A rate limited profile generator is advantageous in that the algorithm is consistently stable, has no DC bias, and the steady state output is always the input, or the desired end position.

Properties of the rate limited profile are present in all the profiles by building subsequent profiles upon the rate limited profile. This provides all the properties of real-time or “on the fly” update of end position and velocity.

The simple rate limited profile creates a versatile profile with many advantages over the method of blending polynomial segments. The velocity of the position profile can be smoothed by convolving the profile with simple Finite Impulse Response (FIR) filter kernels such as the boxcar filter to alleviate discontinuous velocity and infinite acceleration.

When passed through a boxcar filter, for example at Δt_{bc}=0.5 seconds, the velocity of the position profile is transformed from a rectangle to trapezoidal profile as shown in FIG. 4. The time spent in each of the trapezoidal end sections is equal to the duration of the boxcar filter Δt_{bc} and the time spent at the slew velocity (Vₘₐₓ) is reduced by the same Δt_{bc}. Thus, the total time added to the profile is Δt_{bc}. The total time (t_{pf}) spent in the profile is given by:

$${t}_{pf} = \frac{{P}_{f}}{{V}_{rl}} + Δ {t}_{bc} \qquad ( 1 )$$

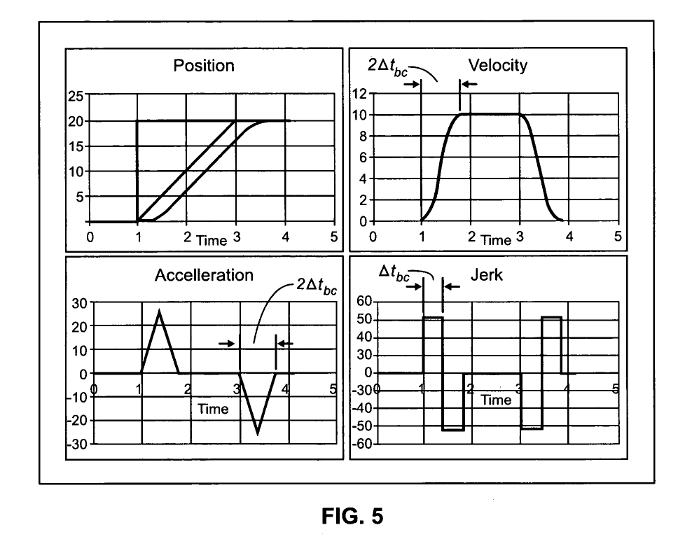

If this position profile is convolved with another boxcar filter, for example at Δt_{bc}=0.4 seconds, the velocity profile is transformed into a trapezoidal with blended ends as shown in FIG. 5. Each time a boxcar is convolved with the profile, the next derivative with respect to time becomes continuous and the time required to traverse the profile increases by the length of the boxcar (Δt_{bc}). The time spent in each of the trapezoidal sections is 2 Δt_{bc} and the time spent at the slew velocity (Vₘₐₓ) is reduced by 2 Δt_{bc}. Thus, the total time added to the profile is 2 Δt_{bc}. The general expression for the total time spent in a rate limited profile convoluted with n_{bc} boxcars is:

$${t}_{pf} = \frac{{P}_{f}}{{V}_{rl}} + {n}_{bc} Δ {t}_{bc} \qquad ( 2 )$$

The boxcar filter is the simplest Finite Impulse Response (FIR) filter kernel and can be replaced with any FIR kernel. According to the present invention, the entire process of profile generation can be thought of as a simple convolution of a FIR kernel and a rate limited profile.

A property of a profile created with the convolution integral is the derivative of the resultant profile is equivalent to both the derivative of the kernel convolved with the profile and the kernel convolved with the derivative of the profile:

$$\frac{d}{d t} ( f * g ) = \frac{d f}{d t} * g = f * \frac{d g}{d t} \qquad ( 3 )$$

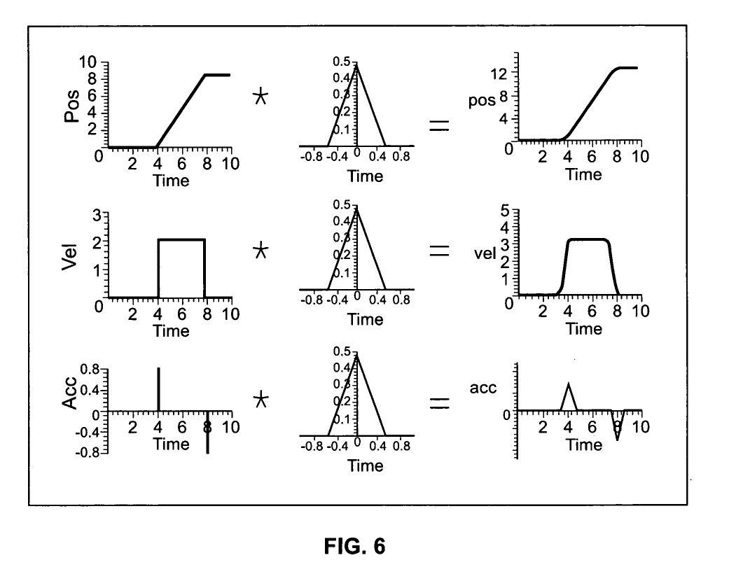

This property gives insight into the shape of the final profile from the shape of the kernel. The impulse delta function δ(t) is the identity operator for the convolution. Any rate limited based profile can be repeatedly differentiated until the final curve results in a series of impulses or delta functions. This derivative can be considered a pseudo identity profile. Convolving a kernel with the identity profile results in a series of the original kernels. When the position profile is a simple rate limited profile convoluted with a kernel, the acceleration profile is a series of kernel profiles placed at the break points of the original profile. FIG. 6 shows the derivative property of convolution created profiles according to the present invention. Therefore, for a rate limited profile the kernel determines the shape of the acceleration of the final profile. If the kernel is continuous, the acceleration is also continuous.

Any repeated application of a boxcar, FIR, or convolution kernel can be reduced to a single filter kernel. A rate limited based profile can be thought of as a single “compound” filter or the combination of a smoothing filter f, a rate limited filter r and a step input s. Depending on the implementation, a single compound filter or the convolved set of simpler base filters is used. A rate limited profile is basically a boxcar filter.

Considering r as a filter will allow for ease in the analysis of the total profile. This gives a final convolution profile made up of two filters and the input step command:

Profile=f*r*s

As shown above, the rate limited profile was applied to the original step input followed by the smoothing filters. Using the associative property of the convolution, the rate limited profile can be added or implemented at any point in the filter.

As shown in FIG. 5 and FIG. 6, smooth profiles were created from a rate limited base profile and boxcar filters. A pulse-based profile such as the three-hump EI can be convolved with this smooth profile. This is essentially the technique used in an Input Shaping approach but, the order used to produce profiles with the convolution operator is not important. According to the present invention, Input Shaping is viewed as a series of pulses convolved with a smoothing filter such as a boxcar or any other FIR filter. The result is then convolved with a rate limited base profile.

By changing the order in which the profile is generated, the smoothing filter is used to improve the frequency spectrum of the final profile. Profiles may then be created in three steps. First, create a pulse-based profile that will eliminate residual vibrations at the desired frequencies. Second, add a smoothing filter that smoothes the profile and improves the spectrum of the profile. Third, the pulses of the smoothing filter and the rate limited profile generate a final profile.

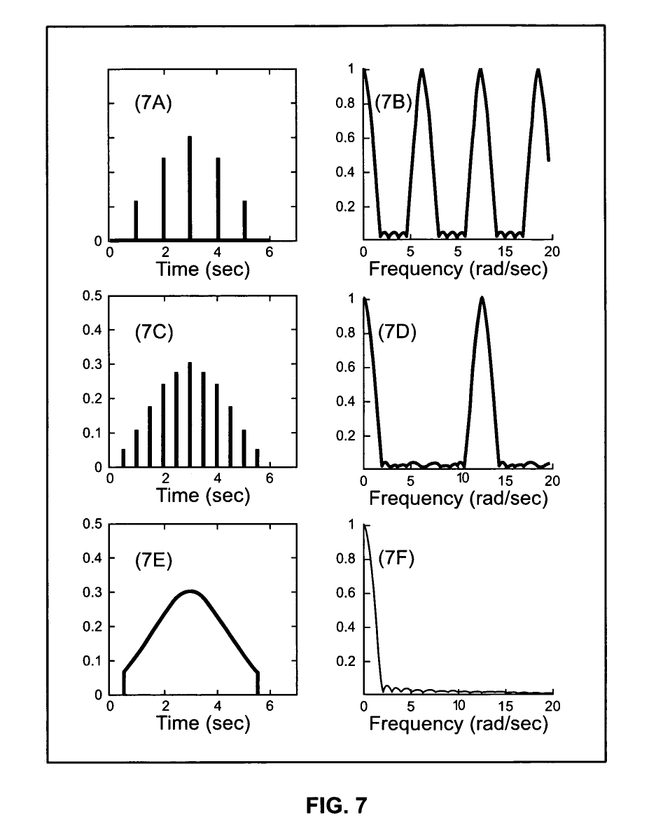

Profiles generated by an Input Shaping approach are a series of pulses separated by a constant time T_{S}. FIG. 7 shows a sampled view of three-hump EI shaper according to the present invention.

For example, the three-hump EI shaper is a series of five pulses as shown in FIG. 7A. Viewing the three-hump EI shaper as five samples of a continuous curve, which always causes aliasing in the frequency domain, the peaks in the frequency spectrum of the EI shaper shown in FIG. 7B can be interpreted as aliasing due to sampling. A quick calculation confirms that the peaks are at the aliasing frequency due to sampling:

$$Ω s = n \frac{2 π}{Ts} \qquad ( 5 )$$

### Where:

Ωs=Aliasing frequencies due to sampling

n=Aliasing peaks (n=1, 2, 3, . . .

T_{S}=Sampling period

When T_{S}=1, then Ω_{S}=2π, 4π, 6π, . . . , 2nπ

The width of the frequency notch of three-hump EI Input Shaping approach can be doubled by halving the sampling period of the continuous curve. An assumption on the shape of the continuous profile must be made. For example, a first approximation of the curve can be made by using a linear interpolation between the original pulses of a three-hump EI Input Shaping profile (T_{S new}=T_{S}/2). The three-hump EI shaper re-sampled with linear interpolation is shown in FIG. 7C and the frequency spectrum re-sampled with linear interpolation is shown in FIG. 7D. As shown, the aliasing peak moves as predicted by equation (5) when T_{snew}=T_{S}/2 (Ω_{S}=4π, . . . , 4nπ).

The Gaussian curve produces the most compact frequency spectrum for a given width in the time domain. Thus, the Gaussian curve is fitted to the three-hump EI shaper points to produce a profile with no aliasing. FIG. 7E shows a truncated Gaussian curve fitted to the five pulses of the three-hump EI shaper points. As shown in FIG. 7F, the frequency spectrum of the Gaussian curve matches the EI input shaper with no aliasing. Thus, the continuous curve increases the usable upper limit to infinity. To realize any profile in hardware, all continuous profiles must be sampled. The real-time implementation of a continuous profile always causes aliasing in the frequency spectrum. It is contemplated that the assumed minimum profile sampling is at least 20 Hz causing the first aliasing peak to appear at or around 125.6 rad/sec.

As shown in FIG. 7, continuous profiles will always outperform pulse-based profiles. Pulse profiles can be replaced with smooth continuous kernels with frequency spectra capable of eliminating residual vibration, or not inducing vibration initially. As stated above, one such kernel is the Gaussian curve:

f(t)=e^{-t}^{²} (6)

The Gaussian curve is infinitely differentiable and its frequency spectrum is also a Gaussian curve. In addition, for the same effective kernel length, the lower end cutoff frequency is higher than that for Input Shaping with triangle pulses. In other words, the length of the kernel for a Gaussian curve will be longer than that of an Input Shaping kernel for the same lower end cutoff frequency. But when the velocity, acceleration, and jerk profiles produced by each kernel are compared, the Gaussian curve generates smoother profiles and reduces the magnitudes of acceleration and jerk.

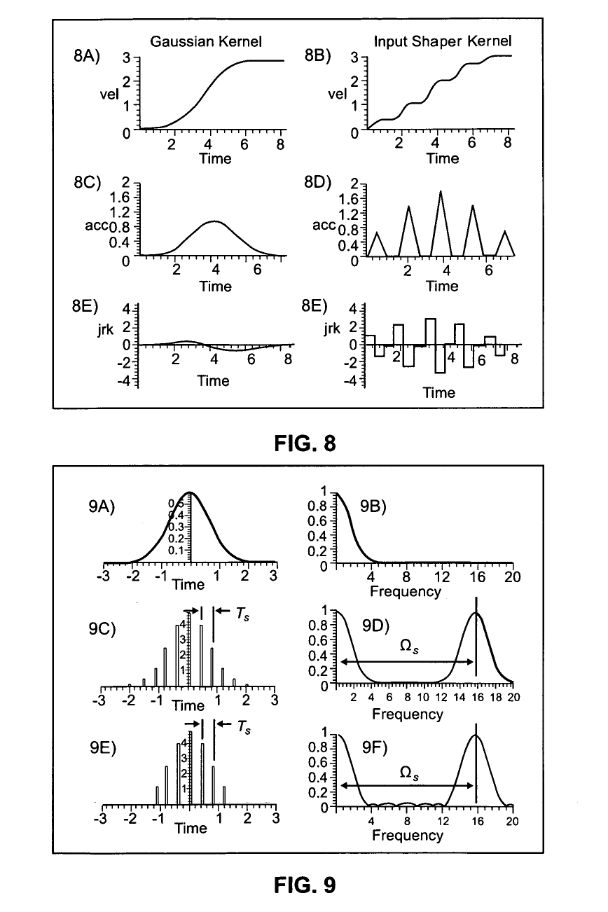

FIG. 8 shows a velocity, acceleration, and jerk comparison between a Gaussian kernel and input shaper kernel according to the present invention. As shown, the acceleration and jerk are 1/2 and 1/4 the values produced by a comparable length input shaper kernel.

A continuous Gaussian curve or a truncated Gaussian curve provides superior results when a wide frequency spectrum notch is required. Pulse-based profiles are more advantageous in implementation. For example, if a digital system runs at 100 Hz then the FIR kernel will have 500 taps (500 terms in its kernel). This requires 500 multiplications and 500 additions to compute the convolution of each frame. Therefore, the three-hump EI shaper and any pulse-based Input Shaping can be implemented as only 5 taps requiring only 5 multiplications and 5 additions even though it is 4 seconds long.

When Input Shaping profiles are viewed as continuous profiles that have been sampled, the realm of pulse-based profiles can be expanded and generalized. The width of the frequency notch created from a sampled curve is defined by the original unsampled curve and the sampling period ΔT_{S}. The shape or the width of the original continuous curve defines the left side or low frequency side of the notch.

FIG. 9 shows the effects of sampling of a continuous curve according to the present invention. Before a curve such as the Gaussian curve is sampled, it can be thought of as a low pass filter as shown by the continuous Gaussian curve of FIG. 9A and frequency spectrum of FIG. 9B. Sampling the curve creates the alias right side or high frequency side of the notch. FIG. 9C and FIG. 9D shows the continuous Gaussian curve with a sampling period of T_{S}=0.4 from t=−2.8 to 2.8 with aliasing at ω=2π/T_{S}=5π. FIG. 9E and FIG. 9F shows the continuous Gaussian curve with a sampling period of T_{S}=0.4 from t=−1.2 to 1.2 with aliasing at ω=2π/T_{S}=5π.

The frequency spectrum of FIG. 9D and FIG. 9F shows the effect of the number of samples taken of a continuous curve holding T_{S} constant. The effect is the same as truncating a continuous curve. Shortening the length of the continuous truncated curve, or decreasing the number of samples, increases the magnitude of the side lobes. When creating a sampled profile, the number of lobes between the aliasing peaks is equal to two less than the number of samples.

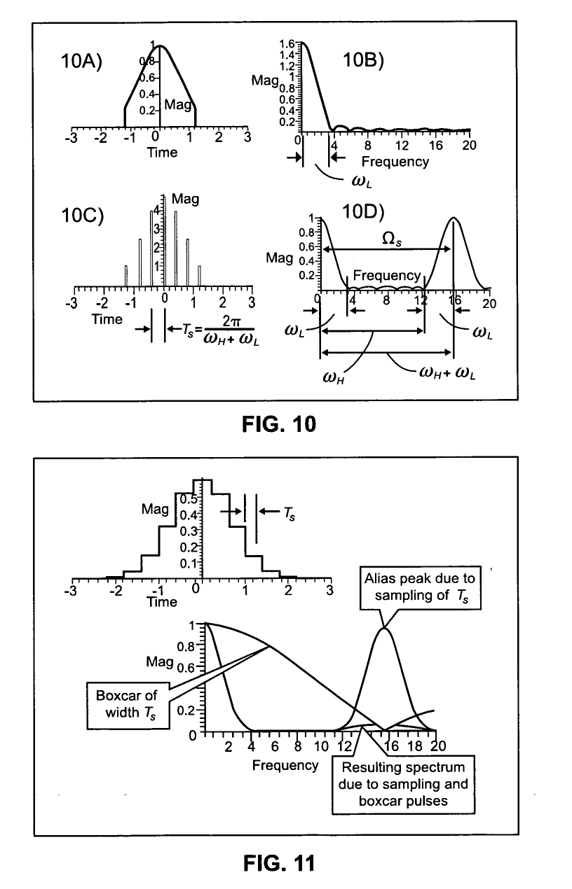

Creating an alias-based profile is done in two steps. First, a low pass filter is designed to form the left side of the ω_{L} as shown in FIG. 10. A windowing technique is used since only pure DC is required, but it is contemplated the design of the low pass filter can be done with any technique. Second, the right side or width of the notch is determined by the placement of the aliasing peak (Ω_{S}). The sampling period T_{S} as defined by equation (5) with n=1. The sampling period T_{S} controls the location of the peak in the frequency domain. The sampling period is a simple function of ω_{H} and ω_{L} defining the notch frequencies as shown in FIG. 10. The duration of the low pass filter can have a length, but may also have the duration of low pass filter equal to an integer multiple of T_{S}:

$${T}_{S} = \frac{2 π}{{ω}_{H} + {ω}_{L}} \qquad ( 7 )$$

Again, an advantage of the pulse-based profile is the reduction in the number of multiplies and additions required to convolve a kernel in real time. As mentioned above, a profile that requires hundreds of taps in a FIR filter can be reduced by orders of magnitude with aliased pulse profiles. In hardware, pulses are represented as boxcars. Even though a boxcar FIR has many taps, it can be programmed in software as one tap requiring only a single multiplication, an addition, and a subtraction. This reduction in mathematical operations occurs because the magnitudes of all the taps in a boxcar FIR are the same. Thus, a boxcar kernel can be considered a single tap FIR filter.

Aliased pulse-based profiles can be taken one step further by taking advantage of converting the pulses into boxcars. If the width of the boxcar pulses Δt_{bc} are equal to the alias sampling period T_{S}, the first null point of the boxcar will align with the first alias peak of the pulse-base profile. FIG. 11 shows the effect of aligning a null point of a boxcar function with an aliasing peak according to the present invention. This eliminates almost all of the alias peaks caused by sampling.

Replacing pulses with boxcars, i.e., convolving the pulse profile with a boxcar, effectively turns a pulse profile into an interpolated finite impulse response (IFIR) filter. The boxcar filter acts like an interpolation function between the pulses; attempting to recreate the original unsampled profile. It is contemplated that any interpolation function can be used, although the use of simple functions keep computations required to a minimum. If two boxcar functions are cascaded together a triangle filter is formed. If the width of the triangle filter is made twice the width of the sampling period, the triangle filter will perform linear interpolation between the pulses of a pulse-based profile. The resulting profile and frequency spectrum starts to resemble the original curve.

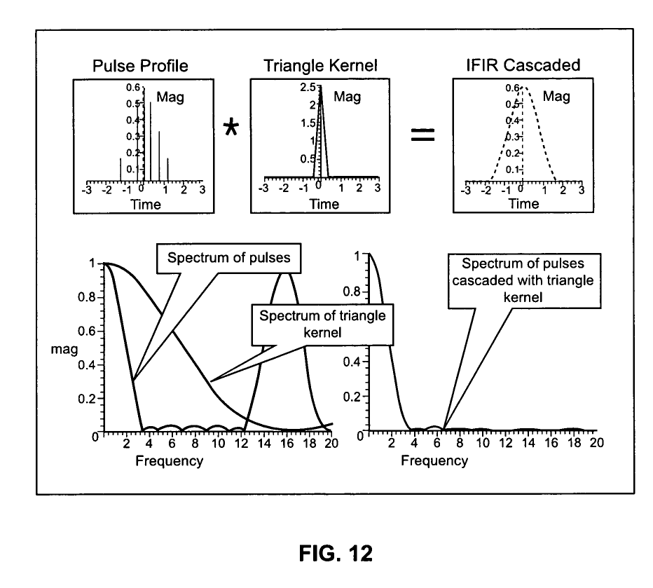

FIG. 12 shows the turning of pulse-based profiles into a linear segment continuous profile according to the present invention. A truncated Gaussian curve is reconstructed with a triangle interpolation filter. The interpolating function acts like a low pass filter that removes aliasing. As with replacing pulses with boxcars, the overall length of the resulting kernel increases when triangles are used. A boxcar interpolator with a width equal to the sampling period T_{S} increases the length of the overall kernel by T_{S}. The use of a triangle interpolator increases the length of the kernel by 2T_{S}.

This configuration of an IFIR may view the interpolation filter as an anti-aliasing filter. The original low pass filter that was sampled to create the pulse profile is recreated.

An expression is determined for the sampling time to create an aliasing low pass filter. In order for a boxcar generated interpolation filter to remove the aliasing peaks its width must be equal to the sampling period T_{S}. An expression was determined for the length of a rate limited smoothed profile. When combined, an expression for the total time required to traverse a pulse generated profile from the starting position to the end position is:

$${T}_{IFIR} = \frac{{P}_{f}}{{V}_{rl}} + {n}_{pulse} ( \frac{2 π}{{ω}_{H} + {ω}_{L}} ) + {n}_{bc} ( \frac{2 π}{{ω}_{H} + {ω}_{L}} ) \qquad ( 8 )$$

As shown in equation 8, the first term is the duration of a rate limited profile, the second term is the duration of the aliasing pulses, and the third term is the duration of the smoothing interpolating filter. The first term is usually a constant for a given trajectory with a required slew velocity. Adjusting the number of pulses (nₚᵤₗₛₑ) and high frequency cutoff (ω_{H}) controls the number and spacing of the side lobes as shown in FIG. 9. The number of boxcar filters (n_{bc}) controls the smoothness of the final curve. The equivalent number of filter taps will be the sum of nₚᵤₗₛₑ+n_{bc}.

Rate limited Boxcar Aliased IFIR (RBAI) profiles were experimentally validated on several multiple mode systems: a multiple pendulum device, a triple pendulum, and a set of slosh tanks. The profiles used to drive the systems were designed to have a low frequency cutoff below the lowest mode in the driven system. A Gaussian window was used for the low frequency aliasing filter with 15 pulses. The IFIR interpolation filter was designed as three passes of a boxcar function to have an infinite upper frequency limit creating a low pass filter profile.

Computer models of the multiple and triple pendulums were first written to test the feasibility of RBAI filters in MATLAB and C++. The classic equation for the modes of a liquid in rectangular tank was used to select the low frequency cutoff for the slosh tanks.

The systems were first modeled in software and driven by pulse-based profiles designed not to induce vibrations. Next the actual test articles were driven by the same profiles to validate the profiles and the models.

When driven with the RBAI profiles, the systems showed no transient or residual vibrations. The only noticeable motion in the systems was a slight start up lag in the pendulums and in the liquid. The lag quickly disappeared with no oscillation as the systems reached the slew velocity and when the systems came to rest. These experiments have shown that using pulse-based profiles with an interpolation IFIR filter can create profiles that mimic Gaussian profiles.

The present invention demonstrates a simpler generalized view of the creation of pulse-based profiles based on digital signal processing windowing techniques. The method turns the windowing functions into an IFIR filter using boxcar functions for the interpolation. The IFIR filter smoothes the pulse-based profiles, allowing the resultant filter to be applied directly over a simple rate limited base profile. These Rate limited Boxcar Aliased IFIR (RBAI) filters create profiles that have the same computational efficiency of Input Shaping profiles such as the three-hump EI Shaper but with capability to create profiles that act as low pass filters. The use of RBAI profiles allow for the width of the notch and the magnitude of the residual vibration in the frequency spectrum to be adjusted separately with no limitations on the number of pulses. Because the frequency spectrum and residual vibration can be controlled separately, the RBAI method produces profiles that are superior to the current Input Shaping techniques.

As implemented, RBAI profiles allow for real-time update of end position and velocity. This is achieved by creating profiles solely from combinations of simple FIR filters.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method for creating a pulse-based motion profile using a digital signal processing technique, comprising the steps:
presenting a continuous window filter;
providing a rate limited base profile;
designing the continuous window filter as a low pass filter to suppress a wide range of frequencies;
sampling the continuous window filter;
transforming the continuous window filter into a discrete filter;
combining the discrete filter with the rate limited base profile; and
applying one or more interpolated finite impulse response filters to remove aliasing peaks and pulses.

2. The method of claim 1, wherein the one or more interpolated finite impulse response filters is a boxcar function.

3. The method of claim 2, wherein said transforming step further comprises the step of equaling the width of the boxcar function to the time of said sampling step.
